(19) United States
(12) Patent Application Publication
(10) Pub. No.: US 2007/0235416 A1
(43) Pub. Date: Oct. 11, 2007

(54) Hole forming method and device

(76) Inventor: John Krug, Orange, CA (US)

Correspondence Address: MICHAEL A. SHIPPEY, PH. D., LAW OFFICES OF KARLA SHIPPEY, 4848 LAKEVIEW AVENUE, SUITE E, YORBA LINDA, CA, 92886, US

(21) Appl. No.: 11/386,883

(22) Filed: Mar. 22, 2006

(51) Int. Cl. B23H 7/00

(52) U.S. Cl. 219/69.12

(57) ABSTRACT

A method and a device is disclosed capable of reliably creating micro apertures as small as 0.0005 inches in diameter at depths of ten times or more the diameter of the wire. The device is comprised of a wire, fitted to a temperature-controlled holder that is further controlled by a cam or similar device to cycle the wire for creating the apertures at a predetermined position and orientation and a second component supporting a workpiece in which the apertures are to be created. The method involves cycling the wire into, through, and out of the workpiece. The cycle begins with the positioning of the wire and the workpiece. As the cam turns, the wire moves toward the workpiece, into and through the workpiece, and then is drawn out to return to its original position. The length of the cycle and the temperature of the wire are critical to providing a hole that is consistent, not tapered, and without residue.

### BACKGROUND OF THE INVENTION

1. Field of the Invention

This invention relates generally to the field of hole drilling, cutting, forming, ablating, and punching devices and methods. More specifically, this invention describes a method and device for creation of apertures of sizes and shapes that can be modified for the requirements of the particular application of the aperture and that can be 0.0005 inches in diameter or smaller at depths of ten times or more the diameter of the wire used for creating the aperture, whereby the diameter remains constant for the entire depth of the aperture and no residue is created.

2. Scope of Prior Art

Hole creation devices and methods have been developed for producing holes in materials, but with significant limitations. Various methods have been employed, namely punching, cutting, and drilling using bits, lasers, and formed punch and plate devices. Some of these methods have been able to produce apertures that are approximately as small as 0.005 in diameter.

As used herein, the terms “hole” and “aperture” are employed interchangeably to mean an opening made into surrounding material, which opening may or may not be completely through the surrounding material. “Micro” holes or apertures may not be easily visible to the naked human eye, but can be seen by means of a microscope. When a hole becomes visible to the naked human eye but is no more than 1 inch in diameter, it is referred to as a “small” hole. Apertures of larger than 1 inch are referred to as “large” holes. For easy reference, the term “wire” is used throughout this specification to refer to the elongated heat-conducting member of the device employed to create holes in a workpiece.

In prior art, drilled micro holes are made using twist drills or spade drills. Micro drill bits are comprised of brittle material and break easily. In current use, these drills can make holes with a depth of approximately four times the diameter of the drill bit before the bit breaks. This method produces a significant quantity of residue during the drilling. The apertures created by drills are limited to the shapes carved out by the moving drill bit, typically circular. These drills have been able to create micro holes no smaller than 0.005 inches in diameter.

If a laser is used to drill micro holes, the holes can be drilled to greater depth. Again, however, the diameter of the holes is limited by the ability to concentrate the light beam, and to apertures produced by prior art lasers have been no smaller than 0.005 inches. Moreover, because of the optics required to concentrate the laser beam, the resulting holes taper inward as the depth increases and therefore the diameter of the hole does not remain constant. Most lasers leave residue, and they are costly to build and operate. An alternative, ultraviolet laser, can ablate holes leaving less residue, but these types of lasers are even more expensive to build and operate.

For hole punches, two parts are required: the punch and a hole plate. The two parts must be made and kept extremely sharp to prevent tearing the workpiece when punching holes. As a result, punches must be frequently taken off-line to be sharpened. Use of a hole punch also limits the type of workpiece. A workpiece must be of sufficient size and shape to allow for the hole plate to be placed on the opposing side in correspondence to the punch. For example, creating a hole plate to fit inside a small diameter tube, such as a catheter, would be extremely difficult and expensive, if not impossible. The hole punch method is further technology-limited when making micro holes of extremely small diameter.

Spinning hollowed tubes having one sharp end have been developed to cut holes in a workpiece, such as one side of a small tube, but they have been successful only for apertures of 0.005 inches in diameter or larger. Spinning tubes have a short life span due to wear, and like drill bits, the shape of the hole produced is limited to the shape created by the spinning tube, typically circular.

Prior art was developed by inventors Yasoda, et al, in U.S. Pat. No. 6,722,245, issued Apr. 20, 2004. This patent describes a punching unit capable of reliably drawing a punch out of a workpiece. Further prior art is found in U.S. Pat. No. 4,554,849, by inventor Benham, of issue date Nov. 26, 1985. This patent describes the punching of pluralities of holes in different radial positions through the wall of a tube, with the aid of a support rod inserted inside the tube.

Yet further prior art is found in U.S. Pat. No. 3,995,518, by inventor Spiroff, issued on Dec. 7, 1976. This patent describes a means for producing holes in flexible catheter tubing through a manual punching device which includes an elongated shank sized for snug fitting disposition within the catheter tube and is provided with a pair of cooperating wedge-shaped elements which are driven against each other by manipulation of the device to drive a punch radially outwardly through the wall of the catheter tube and through a complimentary female die which is snugly disposed against the outer wall of the catheter tube.

Prior art has also been found in U.S. Pat. No. 4,552,600, which teaches perforation of a thermoplastic sheet as part of the manufacturing of a purge trap tray, U.S. Pat. No. 6,888,096, which teaches a laser drilling method for drilling by means of irradiating a workpiece with laser light through a mask having a predetermined pattern, and U.S. Pat. No. 4,203,262, which teaches a device for a cylindrical micro-drill (diameter of tenths of a millimeter to about a millimeter) and a method of making said cylindrical drill comprising a solid non-abrasive filamentary cored portion concentric with the longitudinal axis of the drill and a surrounding solid contiguous portion disposed concentrically about the solid cored portion and comprising abrasive particles in a metallic matrix.

To date, no prior art has found an effective solution for producing micro holes in a workpiece, for example a plastic catheter tube, where the holes are microscopically small-a diameter of 0.005 inch or less—of uniform depth, and of nearly constant diameter for the entire depth, which depth can be at least ten times the diameter of the wire used for forming the aperture. Nor has any prior art been able to form apertures of keyhole, star, and other shapes, nor apertures that curve into or through a workpiece.

### SUMMARY OF THE INVENTION

The method of this invention uses a fine, temperature-controlled wire and a means for moving that wire through a specific hole-forming cycle, the wire being maintained at a required temperature and speed rate during the process and the movement being smoothly consistent to move the wire into, through, and out of the workpiece. This method creates one or more heat-formed holes in a workpiece with no residue. Multiple holes can be created in a single cycle by use of multiple wires in the device.

The terms “wire” and “hole-forming wire” are used herein to refer to the puncturing device that is inserted into the workpiece to create the aperture. The size of this wire is limited only by the capability of technology, and the wire may be composed of any heat-conducting material. Stainless steel is the preferred material for thin, strong wires. However, titanium or other metal wires could be used to good effect in the present device, as could composites such as ceramics and carbon fiber.

As part of this method, it is essential to determine an optimum cycle time measured by speed rate and temperature for forming an aperture in any particular material. This data can be programmed into a computer controlling the hole-forming device, or the cycle can be operated manually.

The optimum cycle time involves determining the speed at which the hole-forming device operates before contact with the workpiece (whether the wire is moved to the workpiece or the workpiece is moved to the wire) (contact time), during insertion of the wire into the workpiece (feed time), during a pause time before removal of the wire (dwell time), and during withdrawal of that wire (removal time).

The optimum temperature is essential to formation of an aperture with the required diameter. If the temperature is too low, said wire will become bent; at a temperature too high, too much of the material of the workpiece will be melted, causing a hole of greater and inconsistent diameter.

This method further requires a determination of the angle at which the workpiece is set in relation to the hole-forming wire and the precise location of the insertion point of the wire. The insertion point and angle will determine whether a penetration remains vertical through the workpiece or curves into and through the workpiece. An approach and insertion that is made at an angle will force a flexible hole-forming wire to bend or a rigid hole-forming wire to break, while an angle that is too great will result in the hole-forming wire “glancing off” of the workpiece without insertion at all.

The device of this invention is an assembly comprised of one or more fine wires that are held in a temperature-controlled clamping device. The clamping device incorporates a variable heating element for accurate temperature control of each wire. The wire clamping device serves to heat and maintain each wire at a specific degree. A cam or other linear motion device controls the movement of the wire clamping device, allowing for smooth insertion of each wire into the workpiece, passage into or through it, a pause within it, and withdrawal from it. The cam or linear motion device operates at variable rates of speed, which can change or stay fixed during each hole-forming cycle as needed to produce the optimum hole-forming cycle. It is necessary to have variable temperatures and variable speeds because workpieces have different compositions and characteristics, thus requiring different temperatures and speeds for optimum formation of parallel apertures without debris.

An object of this invention is to form micro apertures at least as small as 0.005 of an inch in diameter in a workpiece.

Another object of this invention is to form micro apertures having nearly constant diameter through the entire depth of the aperture.

Yet another object of this invention is to form micro apertures that are vertical or near vertical through a workpiece.

A further object of this invention is to form micro apertures of variable sizes, shapes, and configurations, and particularly in shapes that cannot be made with a spinning or rotating tool and that cannot be hole-punched.

An object of this invention also is to form micro apertures without leaving residue from the workpiece.

Another object of this invention is to create holes that are 10 times or more in depth than the diameter of the hole-forming wire.

This invention has many significant applications. The applications described herein are just a few of the ones anticipated, and these are not intended to be limiting. There are numerous other applications and opportunities for this invention. Other uses and features of the current invention will become apparent from the following description of the preferred embodiment in the detailed written specification and accompanying drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention. It is further to be understood that the drawings are provided for purposes of illustration and description, and are not to be construed as limiting this invention.

FIG. 1 is a schematic drawing of the entire assembly of this invention from a frontal view.

FIG. 2 is a schematic drawing of the entire assembly of this invention from a right side view.

FIG. 3 is a schematic drawing of the entire assembly of this invention from a left side view.

FIG. 4 is a schematic illustration of the movement device, clamping device, wire being used to form apertures in a curve in the workpiece.

FIG. 5 is a schematic illustration of the movement device, clamping device, and wire positioned to form a hole in a tubular workpiece.

FIG. 6 is a schematic illustration of the movement device, clamping device, and wire being inserted into a tubular workpiece to form an aperture.

FIG. 7 illustrates different aperture shapes that can be formed by using wires of differing shapes.

FIG. 8 is a schematic illustration of the movement device, clamping device, and wire positioned after being withdrawn from a curved hole it has formed in a workpiece.

FIG. 9 is a schematic illustration of the device showing one illustrative configuration of the use of multiple wires for the formation of multiple holes.

FIG. 10 is a graph illustrating a determination of preferred temperature in one example of a workpiece, namely a PVC pipe.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art of micro aperture formation to employ the present invention in virtually any appropriately detailed system, structure, or manner.

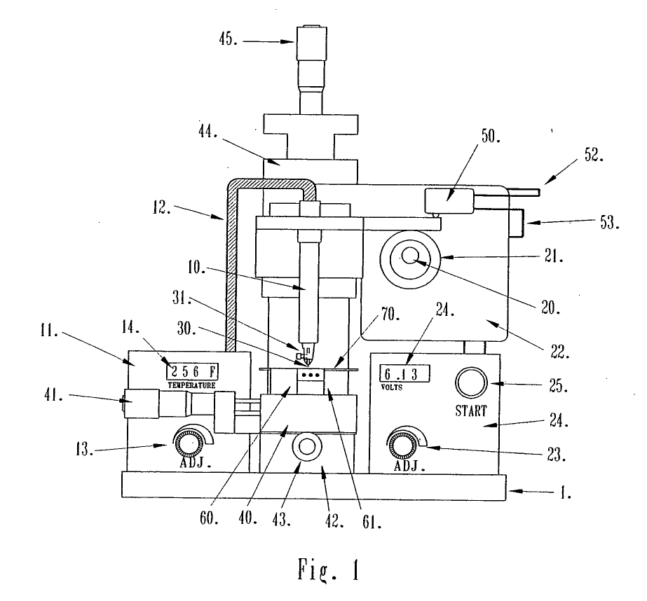

FIG. 1 is a schematic drawing showing a frontal view of the entire assembly of this invention. The assembly is shown constructed on a single base 1, although the components of this assembly can be placed on more than one base, at differing levels and relative locations. The several components are modular, and as such are capable of a variety of configurations as needed to accommodate space, convenience, production, and other similar requirements. The assembly can even be made portable if necessary.

Said assembly consists of a heating element 10 attached by a flexible electrical cord 12 to a temperature adjustment controller 11 to set and maintain the temperature of the heating element 10. The heating element 10 heats the hole-forming wire 30, which is attached to the heating element by means of a clamp 31. The position of the hole-forming wire 30 can be adjusted vertically by means of a Z-axis stage 44 with a micrometer adjusting device 45, to which the heating element 10 is mounted.

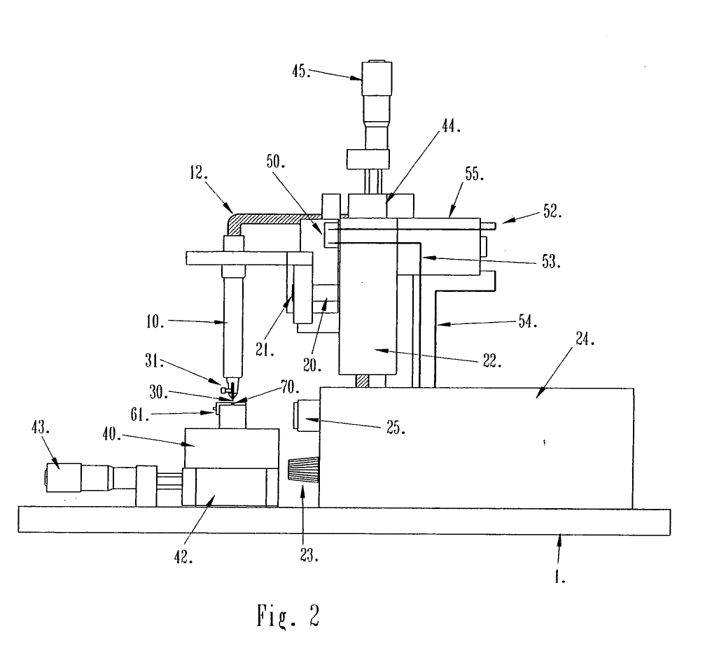

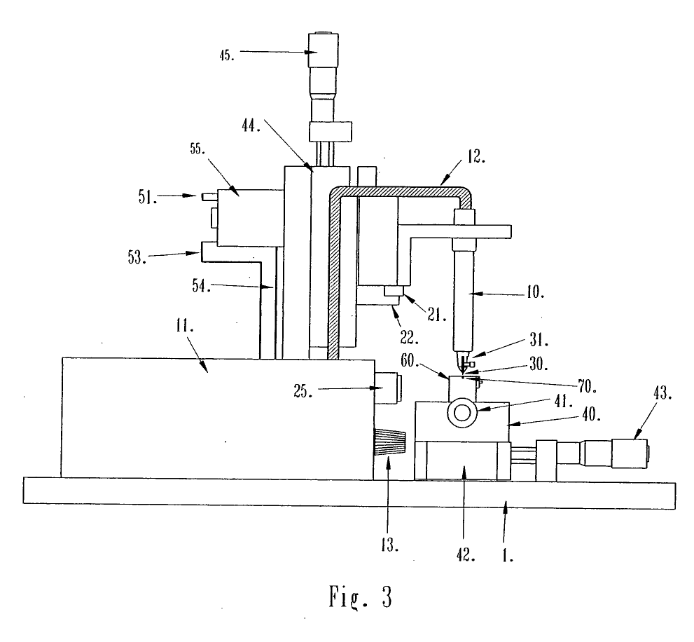

The heating element 10, needle clamp 31, and hole-forming wire 30 are moved during a hole-forming cycle vertically by means of a motorized movement device 20 and cam roller 21, in this drawing illustrated as a gear drive 22 and electric motor 55 (as shown in FIGS. 2 and 3). The movement device must provide smooth motion, and while a motorized cam is a preferred means, other similar devices can be substituted. The speed of movement is varied by means of a voltage adjustment controller 23 that controls the voltage to the movement device 20, said voltage serving in this illustration to operate the gear drive 22 and the electric motor 55 (as shown in FIGS. 2 and 3) operating the cam roller 21. The hole-forming wire 30 is positioned above a workpiece 70, also held in position by means of a clamp 61 or similar device, which clamp can be adjusted at two points in the X axis and Y axis by means of the X axis stage 40 with a micrometer adjusting device 41 and the Y axis stage 42 with a micrometer adjusting device 43 that are 90 degrees apart for optimum positioning of the workpiece. The X axis and Y axis adjustment are crucial to ensure that the angle of the workpiece to the hole-forming device is accurate. Workpiece clamp 61 is in turn supported by clamp base 60.

The assembly also may include a limit switch 50. The start button 25 is provided to bypass the limit switch 50, allowing the motor 55 to close the limit switch 50 and cause the movement device 20 to rotate through a hole-forming cycle. This limit switch and start button arrangement are useful in manual operation of the device, but can be eliminated in the automated version.

Precision is of high importance in this hole-forming process, and accordingly, an operator may need to monitor the wire and hole formation. For monitoring during a hole-forming cycle, a video camera or other similar device can optionally be mounted on brackets where convenient for viewing the hole-forming wire and workpiece, and this video camera can be connected to a video or other monitor for easy continuous viewing during the cycle.

The method for aperture formation begins with testing of the workpiece material to determine the optimum temperature and speed for forming a micro aperture. Often, information is available in the published literature which will assist in this determination. A good starting place is about 30° F. lower than the published melting point of the substrate material.

If a curved aperture is desired, it is further necessary to determine the optimum angle of the workpiece in relation to the hole-forming wire.

Once the optimums are determined, the workpiece 70 is set into the clamp mechanism 61, which is adjusted in the X and Y axis positions using the X stage 40 and micrometer adjustment device 41, and the Y stage 42 and micrometer adjustment device 43. The depth is set by adjusting the Z stage 44 and micrometer adjustment device 45. The operator can set the vertical speed rate by adjusting the variable voltage power supply adjustment knob 23 and the temperature by adjusting the variable temperature controller adjusting knob 13.

The hole-forming cycle is then begun by pushing the start button 25 to override the limit switch 50 until the cam roller 21 moves the hole-forming wire toward the workpiece a sufficient distance to allow the limit switch 50 to complete the electrical circuit, providing power to the motor 55 (see FIGS. 2 and 3) so that the start button 25 is no longer required to be held in the closed position.

This procedure and these adjustments allow for optimal hole-forming of micro apertures of constant depth and diameter in the particular material of the workpiece. If used, optional video cameras and monitoring screens can be employed to ensure the accurate operation of the hole-forming cycle creating the aperture. Said monitoring can continue for each hole-forming cycle until the workpiece has been perforated the required number of times. Said monitoring also serves the function of verification of wire integrity. Should the wire fail, it can easily be replaced by loosening needle clam 31, removing the old wire 30, and replacement with a new wire 30.

The present invention is capable of forming holes of precise diameter as small as 0.0005 inches. It will form holes with perfectly vertical walls, as deep as 20 times the diameter of the hole. With proper operation, walls remain stable and stringers or other debris is not formed.

FIG. 2 is a diagram of the entire assembly of this invention from a right side view. This depicts the wire 30, wire clamp 61, wire heater 10, above the two workpiece adjusters 40, 41, itself mounted on the base plate 1. To the right side is the variable voltage controller 24, with start button 51. Above this is the gear drive 22, driven by the motor 55, and the Z axis stage 44.

FIG. 3 is a diagram of the entire assembly of this invention from a left side view. This is the reverse view of FIG. 2. The same elements are shown from the left side.

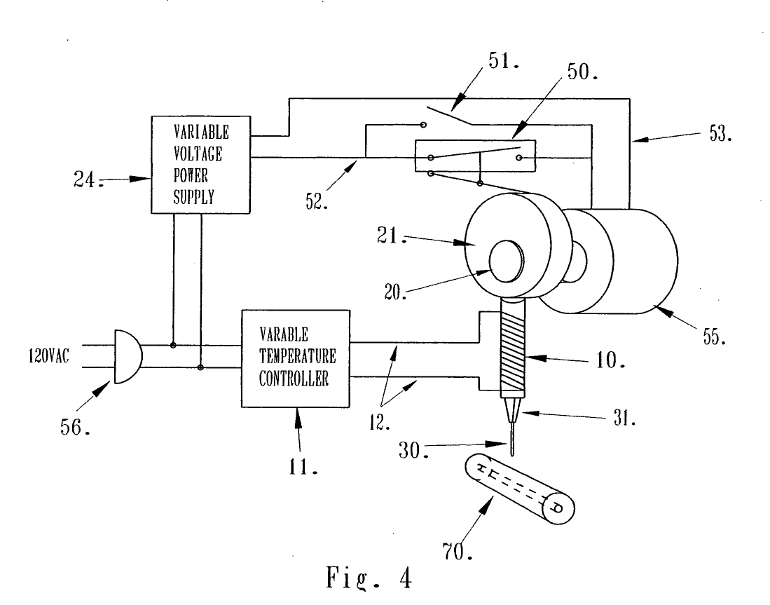

FIG. 4 is a schematic illustration of the operation of the hole-forming device. Workpiece 70, in this illustration a tube, is shown in position to have a micro hole formed in it by moving wire 30, clamp 31, and heating element 10, toward the tube and into the tube 70. When the roller cam 21 is operated by the motor shaft 20, which is turned by electric motor 55, these three parts 30, 31, move toward the workpiece and the wire enters the workpiece. When the start switch 51 is closed, the variable voltage power supply 24 provides energy to the motor 55 and bypasses the limit switch 50 until the roller cam 21 has moved down enough to close the limit switch 50 and continue the downward movement of these elements 30, 31, 10 so the start switch 51 is no longer required to be held in the closed position. A variable temperature controller 11 is shown which controls the temperature of the heating element 10, clamp 31, and wire 30, which will form the aperture in the workpiece 70. A 120 volt alternating electrical power plug 56 is used to supply electrical energy to the entire device.

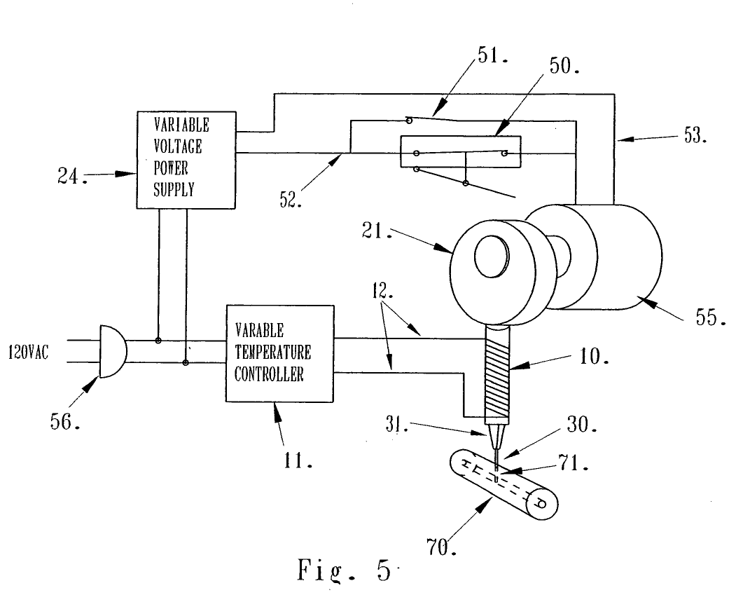

FIG. 5 is essentially the same schematic illustration of the operation of the hole-forming device of FIG. 4, except that the roller cam 21 is shown in the fully descended position so that elements 10, 30, and 31 have moved toward and into the workpiece 70 creating an aperture therein. The start switch 51 and limit switch 50 are shown in the closed position. The start switch 51 can be shown in the open position because the limit switch 50 which is shown in the closed position has completed the electrical circuit to the motor 55. At this point the start button 25, which controls the position of start switch 51, is no longer required to be depressed.

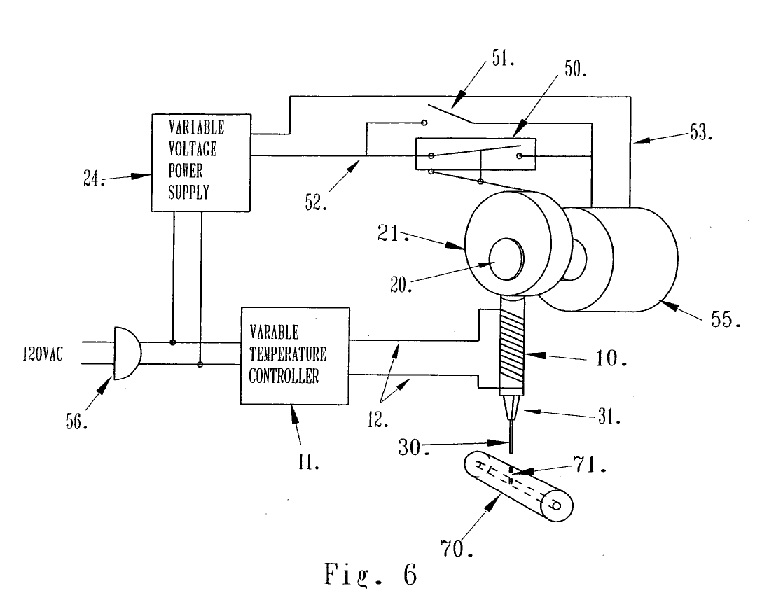

FIG. 6 is essentially the same as the schematic illustration of the operation of the hole-forming device of FIGS. 4 and 5, except that the device has returned to its original position in FIG. 5 and the hole 71 can be seen in the workpiece 70, which hole is illustrated here by broken lines in the workpiece.

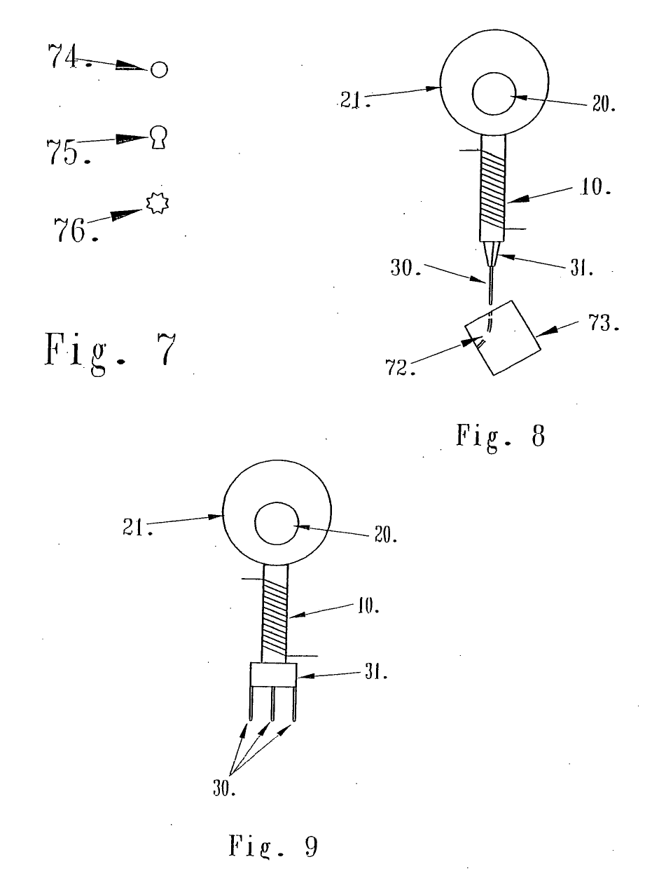

FIG. 7 illustrates different aperture shapes that can be formed by using wires of differing shapes, such as round wire 74, keyhole wire 75, and star-shaped wire 76. Other shapes can be made. The shape of the aperture is important in sorting and filtration applications.

FIG. 8 illustrates the ability of the hole-forming wire 30 to make a curved hole 72 in the workpiece 73. Curved holes are the result of the angle of the surface of the workpiece 73 in relation to the hole-forming wire 30.

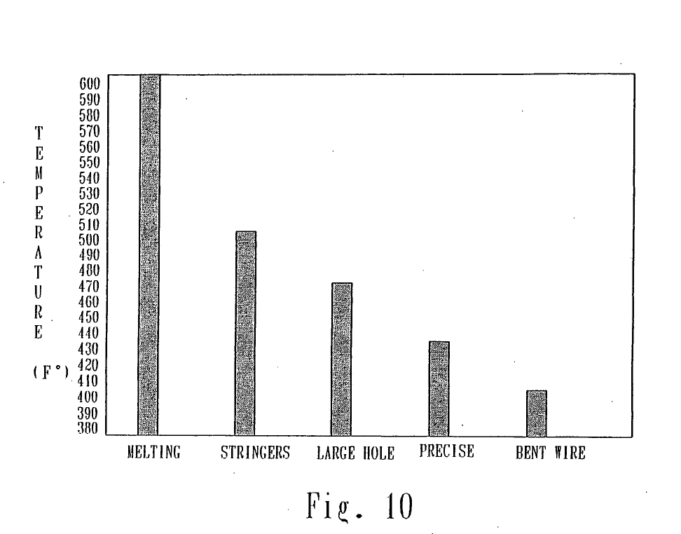

FIG. 9 illustrates that more than one hole can be formed at the same time in a hole-forming cycle simply by adding additional wires 30. It is understood that the heating element 10 would need to be increased in heat transfer ability so that more than one hole-forming wire 30 could be maintained at the same and proper temperature for quality hole-forming.

FIG. 10 illustrates the optimum temperature for creating apertures in a workpiece consisting of a PVC tube. At 600° F., the PVC tube will melt. Insertion of the hole-forming wire at a temperature of about 500° F. will create “stringers” from the aperture formed, leaving significant residue. At about 460° F., an aperture will be formed that is too large in diameter because too much of the PVC tube has melted. A few degrees lower, 430° F. will create the perfect-size hole for this type of workpiece, but if the temperature lowers just a few more degrees, to 400° F., the hole-forming wire will bend and possibly break instead of entering the workpiece. These numbers are illustrative only and will vary with the material that is being perforated. Also, the optimum hole-forming cycle time and temperature of any particular material can vary significantly (at least +/−200° F. just for a range of plastics).

A preferred sequence for the cycle of the hole formation, with indicated time allotments, includes:
a. Static time while at rest (variable);
b. Descent time while approaching the substrate (2.5 seconds);
c. Piercing time while puncturing the substrate (2.0 seconds);
d. Dwell time within the substrate (0.5 seconds); and,
e. Removal time to retreat to the rest position (5.0 seconds).

The static time will typically only come into play if the time to advance the substrate into a new position is significant. This is often the case for a manual embodiment of the current invention, but would not be necessary in an automated version.

The automated version of the current invention includes computer control of the motors activating the hole-formation sequence. Furthermore, the computer will control the automatic advancing of a substrate. Automatic substrate advancing can be accomplished by a linear motor and electric control, of the type that is common in the industry. Examples can be found in the catalog provided by the McMaster-Carr Supply Company, a nationwide distributor with Los Angeles office at: 9630 Norwalk Blvd, Santa Fe Springs, Calif. 90670-2932. They are located on the internet at http://www.mcmaster.com/.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A device for creating apertures in a substrate object, comprising:
f. At least one elongated member, each such elongated member capable of retaining its shape when heated to a temperature appropriate for puncturing the substrate;
g. A heat source, to heat the elongated member;
h. A motor, to transport the elongated member in a motion appropriate for puncturing said substrate;
i. Means to support the elongated member in a position appropriate for said puncturing;
j. Control means to operate the motion of the elongated member; and,
k. Control means to operate the heat source.

2. The device of claim 1, wherein said heat source and control means is capable of controlling the temperature of the elongated member to within a range of +/−5 degrees Fahrenheit.

3. The device of claim 1, further comprising a cam to control the motion of said elongated member.

4. The device of claim 1, further comprising means to transport a substrate object past the striking position for the elongated member, thereby enabling said elongated member to strike several apertures in said substrate.

5. The device of claim 1, wherein said elongated member has a diameter within the range of 0.0005-0.005 inches.

6. The device of claim 1, further comprising timing means to control the elongated member motion.

7. The device of claim 1, wherein said elongated member is comprised of heat-conductive material.

8. The device of claim 1, further comprising means to fasten the elongated member position in the two orthogonal dimensions of front-to-back and side-to-side.

9. The device of claim 1, further comprising means to fasten the substrate in a fixed position during the puncturing process.

10. The device of claim 1, wherein said elongated member comprises a length sufficient to pierce said substrate to a depth of between 1 to 20 times the diameter of the aperture produced.

11. The device of claim 1, further comprising a modular bracket holding a plurality of parallel elongated members, enabling the simultaneous piercing of a plurality of parallel apertures.

12. The device of claim 1, wherein said elongated member comprises a wire.

13. The device of claim 12, further comprising means to easily replace said wire.

14. The device of claim 1, wherein said elongated member comprises a non-circular, geometric shape at the free end thereof.

15. A method for creating apertures in a substrate object, comprising the use of the device of claim 1, wherein an elongated member heated to a temperature appropriate for puncturing the substrate is inserted into the substrate at an appropriate speed for puncturing the substrate to form an aperture of a specific diameter without leaving residue.

16. The method of claim 15, further comprising a sequence for the motion of the elongated member which includes:
a. Static time while at rest;
b. Descent time while approaching the substrate;
c. Piercing time while puncturing the substrate;
d. Dwell time within the substrate; and,
e. Removal time to retreat to the rest position.

17. The method of claim 15, further comprising means to control the position of said elongated member.

18. The method of claim 15, further comprising means to control the temperature of said elongated member.

19. The method of claim 15, further comprising the centered, vertical motion of said elongated member to create a vertical hole of uniform diameter throughout its depth.

20. The method of claim 15, further comprising the vertical non-centered motion of said elongated member to create a curved hole of uniform diameter throughout its depth.

21. The method of claim 15, further comprising automated means to control the motion of said substrate into position for repeated apertures to be created.

22. The method of claim 15, further comprising automated means to control the elongated member heating.

23. The method of claim 15, further comprising automated means to control the motion of said elongated member.

24. A device for creating apertures in a substrate object, comprising:
a. At least one elongated member, each such elongated member being heat-conductive, and capable of retaining its shape when heated to a temperature appropriate for puncturing the substrate;
b. A heat source, to heat the elongated member;
c. A motor, to transport the elongated member in a motion appropriate for puncturing said substrate;
d. Means to support the elongated member in a position appropriate for said puncturing;
e. Means to immobilize the substrate object during puncturing;
f. Means to advance the substrate object after puncturing;
g. Control means to operate the motion of the elongated member; and,
h. Control means to enable the heat source to maintain a temperature within a range of +/−5 degrees Fahrenheit.

25. The device of claim 24, further comprising means to control a sequence for the motion of the elongated member which includes:
a. Descent time while approaching the substrate;
b. Piercing time while puncturing the substrate;
c. Dwell time within the substrate; and,
d. Removal time to retreat to the rest position.
